(19) United States
(12) Patent Application Publication
(10) Pub. No.: US 2025/0078295 A1
(43) Pub. Date: Mar. 6, 2025

(54) RECONSTRUCTION OF DEPTH INFORMATION AND OTHER ADDITIONAL QUANTITIES FROM TWO-DIMENSIONAL IMAGES

(71) Applicant: Robert Bosch GmbH, Stuttgart (DE)

(72) Inventors: Volker Fischer, Renningen (DE); Chaithanya Kumar Mummadi, Coraopolis, PA (US); Sascha Wirges, Buehl (DE); Eashwara Sudharsan Erahan, Hildesheim (DE)

(21) Appl. No.: 18/816,579

(22) Filed: Aug. 27, 2024

(30) Foreign Application Priority Data
Sep. 6, 2023 (DE) 10 2023 208 616.6

(51) Int. Cl. G06T 7/50; B60W 60/00; G05D 1/43

(52) U.S. Cl. CPC G06T 7/50; B60W 60/001; G05D 1/43; G06T 2207/20084

(57) ABSTRACT

A method for reconstructing a location-dependent scalar additional quantity of a scene from an image of the scene divided into pixels. The method includes: feeding pixel values of the image to a neural network; processing the pixel values by the neural network to produce local difference information, which in each case indicates how the location-dependent scalar additional quantity of the scene changes at the position indicated by the particular pixel; ascertaining the scalar additional information for further locations indicated by pixels of the image, from the local difference information.

### CROSS REFERENCE

The present application claims the benefit under 35 U.S.C. § 119 of German Patent Application No. DE 10 2023 208 616.6 filed on Sep. 6, 2023, which is expressly incorporated herein by reference in its entirety.

### FIELD

The present invention relates to the enrichment of two-dimensional images with depth information and other additional quantities that relate to the depicted scene and are important, for example, for planning the behavior of vehicles or robots.

### BACKGROUND INFORMATION

Autonomously moving agents, such as vehicles or robots, rely on continuous monitoring of their environment. An important source of information for this purpose is camera images. Usually, two-dimensional cameras are used because it is quite complex and expensive to cover the entire environment with stereoscopic or other three-dimensional cameras.

Two-dimensional images are therefore enhanced by a subsequent reconstruction of the depth information using neural networks. Y. Ming et al., “Deep learning for monocular depth estimation: A review,” Neurocomputing 438, 14-33, doi: 10.1016/j.neucom.2020.12.089 (2021) gives an overview of common methods in this regard.

### SUMMARY

The present invention provides a method for reconstructing a location-dependent scalar additional quantity of a scene from an image of this scene divided into pixels. According to an example embodiment of the present invention, as part of this method, pixel values of the image are fed to a neural network. This neural network processes the pixel values to produce local difference information, which in each case indicates how the location-dependent scalar additional quantity of the scene changes at the position indicated by the particular pixel. Said scalar additional information is ascertained from the local difference information for further locations indicated by pixels of the image.

In this case, the scalar additional quantity can, for example, in particular include depth information that is a measure of a distance between a part of the scene and a camera used to record the image. The depth information can thus, for example, indicate the distance between matter-filled areas of the scene at the positions indicated by the pixels, on the one hand, and the camera or else a plane in which the camera is located, on the other hand. However, other scalar additional quantities are also possible, such as a density or another material property of matter present in the scene.

It was recognized that ascertaining local difference information of the scalar additional quantity is significantly less prone to errors than ascertaining absolute values of the scalar additional quantity. In particular, when ascertaining local difference information, the absence of individual values is tolerated much better than when ascertaining absolute values. At the same time, for many applications, relative information about the scalar additional quantity, such as the depth information, is completely sufficient. If, for example, a robot or other production machine is to grip components that are to be assembled during production, then the information about which areas of the scene shown in the recorded image are deeper than others is already sufficient. For the end result, i.e., the reliability with which the robot or the production machine grips the components, it is better to calculate only the actually needed information with good accuracy than to additionally calculate not absolutely necessary information and to sacrifice the overall accuracy. Furthermore, especially for objects that are far away, such as in traffic situations, it is much more difficult to measure a distance absolutely than to measure relative changes in this distance.

In a particularly advantageous example embodiment of the present invention, the neural network ascertains local difference information based on a reference pixel, which local difference information includes the changes in the location-dependent scalar additional quantity between the position indicated by the reference pixel, on the one hand, and the positions indicated by various neighboring pixels, on the other hand. From this, it is then clear in which direction in the image the scalar additional information changes and to what extent. For example, if a pixel defined by the coordinates (i,j) has four neighbors, each of which is shifted by one pixel in one of the coordinates (i,j), there are four local difference information items for the pixel (i,j). For example, the local difference information can be local depth differences LDD(i,j) that relate to the absolute depths D(i,j). For the four neighborhood relationships mentioned above, four local depth differences result per pixel:

$$\begin{matrix}{LDD}_{1 , 0} ( i , j ) = D ( i , j ) - D ( i + 1 , j ) , \\ {LDD}_{0 , 1} ( i , j ) = D ( i , j ) - D ( i , j + 1 ) . \\ {LDD}_{- 1 , 0} ( i , j ) = D ( i , j ) - D ( i - L j ) , \\ {LDD}_{0 , - 1} ( i , j ) = D ( i , j ) - D ( i , j - 1 ) .\end{matrix}$$

From this, it is in particular clear in which direction the depth D changes the most. For further refinement, the neighbors that are shifted by one pixel in both coordinates (i,j) can optionally also be included.

Alternatively or in combination with this, differences between more distant pixels can also be included, for example LDD_{0,2}(i,j).

In a further, particularly advantageous example embodiment of the present invention, at least one reference indication of the location-dependent scalar additional information for at least one position in the scene is additionally included in the ascertainment of the scalar additional information for further locations. In this way, the ascertained relative scalar additional information can be transferred to an absolute scale. When multiple reference indications are used, the accuracy of each of these reference indications is less critical.

In a further, particularly advantageous example embodiment of the present invention, a cost function is used to evaluate the extent to which multiple differences of the scalar additional quantity between two predetermined locations in the scene, which differences have been aggregated on different paths from multiple local difference information items, are consistent with each other. Parameters that characterize the behavior of the neural network are optimized with the aim of improving the evaluation by the cost function. In this way, the neural network can be trained in a self-supervised manner, i.e., without using prior knowledge (“ground truth”). In this case, it may in particular be required, for example, that the differences D(p₂)−D(p₁) of the scalar additional quantity that have been aggregated on all possible paths ϕ=(p₁, (dp₁^{ϕ}, . . . , dpₘ^{ϕ})), where ϕ₀=p₁ and ϕₘ=p₂, between a first location p₁ and a second location p₂ are the same:

$$D ( {p}_{2} ) - D ( {p}_{1} ) = {\sum }_{i = 1}^{m} {LDD}_{d {p}_{i}^{Φ}} ( {Φ}_{i} )$$

for all paths ϕ. The set of ascertained local difference information items is then called “path-consistent.” This is analogous, for example, to the conservation of energy in conservative force fields, where the same work is always done on any path between two given locations p₁ and p₂.

In particular, there may be applications in which no training examples labeled with “ground truth” regarding the scalar additional quantity are available. Only the self-supervised training mentioned above is available in this case. However, this self-supervised training can also be combined with any form of training supervised with “ground truth.” For example, a cost function of the supervised training and a cost function of the self-supervised training can be aggregated into a total cost function, for example by adding them.

In a further advantageous example embodiment of the present invention, the neural network is additionally designed to ascertain absolute values of the location-dependent scalar additional quantity for the positions indicated by the pixels. In this way, the ascertainment of absolute values on the one hand and the ascertainment of local difference information (and, from this, optionally, relative values of the scalar additional quantity) on the other hand can support each other. In particular, the ascertained absolute values on the one hand and the ascertained local difference information on the other hand can, for example, be checked against each other for plausibility. A measure of the reliability of the absolute values and/or the local difference information can then be ascertained from the result of the plausibility check. The information about this reliability is in particular important for controlling vehicles, robots, or production machines. For example, the more reliably depth information about a scene has been ascertained from recorded images of this scene, the faster the vehicle, robot, or production machine can move through this scene.

In a further, particularly advantageous example embodiment of the present invention, the neural network outputs a quotient of the local difference information and the value of the location-dependent additional quantity at the position indicated by the particular pixel. In the above example of depth information, this quotient dependent on the location p is, for example, given by

$$NLDD ( p ) = \frac{LDD ( p )}{D ( p )} .$$

The advantage of normalization to the scalar additional quantity, in this case D (p), is that the quotient is dimensionless, i.e., it no longer includes any physical unit of measurement. It indicates the change in depth, for example, depending on this depth. For many applications this is especially important. For example, the rate of change of the distance to an object in relation to the absolute distance is a measure of how imminent a collision with this object is.

In a further, particularly advantageous example embodiment of the present invention, the image enriched by the ascertained scalar additional quantity is fed to a classifier network, which assigns classification scores with respect to one or more classes of a predetermined classification to the scene and/or at least one object contained in the scene. In this way, ambiguities, which would remain if only the image were used, can be resolved. For example, it is possible to distinguish whether the scene merely contains a photo or other image of an object or whether this object is actually physically present in the scene.

In a further, particularly advantageous example embodiment of the present invention, the image enriched by the ascertained scalar additional quantity is included in the planning of the movement of a vehicle, a robot, and/or a production machine designed to pick up and assemble components. The vehicle, robot, or production machine is controlled according to this planning. In this way, the probability is increased that the response of the vehicle, the robot, or the production machine to the control is appropriate to the scene represented by the image and the scalar additional information ascertained therefrom. This improves the overall performance of the vehicle, robot, or production machine.

The present invention also provides a method for training a neural network for use in the method of the present invention described above.

According to an example embodiment of the present invention, as part of this method, training images of at least one scene are provided. In the interest of better generalization, the training images can, for example, in particular relate to many different scenes.

Pixel values of the training images are fed to the neural network to be trained. These pixel values are then processed by the neural network to produce local difference information, which in each case indicates how the location-dependent scalar additional quantity of the scene changes at the position indicated by the particular pixel.

A predetermined cost function is used to evaluate the extent to which the ascertained local difference information is consistent with the predetermined target information regarding the location-dependent scalar additional quantity in the scene. This can be measured by any metric, depending on the type of target information that is actually available. It is therefore not only possible to directly compare the local difference information to the target information but also, for example, to check to what extent the ascertained local difference information contradicts the target information.

Parameters that characterize the behavior of the neural network are optimized with the aim of improving the evaluation by the cost function.

In a particularly advantageous example embodiment of the present invention, local target difference information is ascertained from predetermined target absolute values for the location-dependent scalar additional quantity. The local difference information ascertained by the neural network to be trained is compared to the local target difference information so that a local deviation is produced. The cost function depends on said local deviation. The absolute target values can be ascertained particularly simply using measurement technology, for example by scanning the scene using lidar or another sensor.

In a further advantageous example embodiment of the present invention, absolute values of the location-dependent scalar additional quantity for the positions indicated by the pixels are ascertained by the neural network and/or from the local difference information provided by the neural network. The absolute values ascertained by the neural network to be trained and/or from the local difference information provided by the neural network are compared to predetermined target absolute values so that an absolute deviation is produced. The cost function also depends on said absolute deviation. In this way, the ascertainment of local difference information by the neural network to be trained can be used as regularization for the ascertainment of the absolute values by the same neural network.

For this purpose, new local target difference information can be ascertained, for example, in particular from the same target absolute values that are used for training with respect to ascertaining absolute values, as described above. It is, for example, also in particular possible, as described above, to train for path consistency in a self-supervised manner.

The methods of the present invention can in particular be wholly or partially computer-implemented. The present invention therefore also relates to a computer program comprising machine-readable instructions that, when executed on one or more computers and/or compute instances, cause the computer(s) and/or compute instance(s) to perform one of the described methods of the present invention. In this sense, control devices for vehicles and embedded systems for technical devices, which are also capable of executing machine-readable instructions, are also to be regarded as computers. Compute instances can, for example, be virtual machines, containers or serverless execution environments, which can in particular be provided in a cloud.

The present invention also relates to a machine-readable data carrier and/or to a download product with the computer program of the present invention. A download product is a digital product that can be transmitted via a data network, i.e., can be downloaded by a user of the data network, and can, for example, be offered for immediate download in an online shop.

Furthermore, one or more computers and/or compute instances can be equipped with the computer program of the present invention, with the machine-readable data carrier, or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 for reconstructing a location-dependent scalar additional quantity 5 from an image 2 of a scene 1, according to the present invention.

FIG. 2 shows an exemplary embodiment of the method 200 for training a neural network 3, according to the present invention.

FIGS. 3A and 3B show two different ways of using predetermined target absolute values 5a* as “ground truth” for the training according to the method 200, according of the present invention.

### DETAILED DESCRIPTION OF EXAMPLE EMBODIMENTS

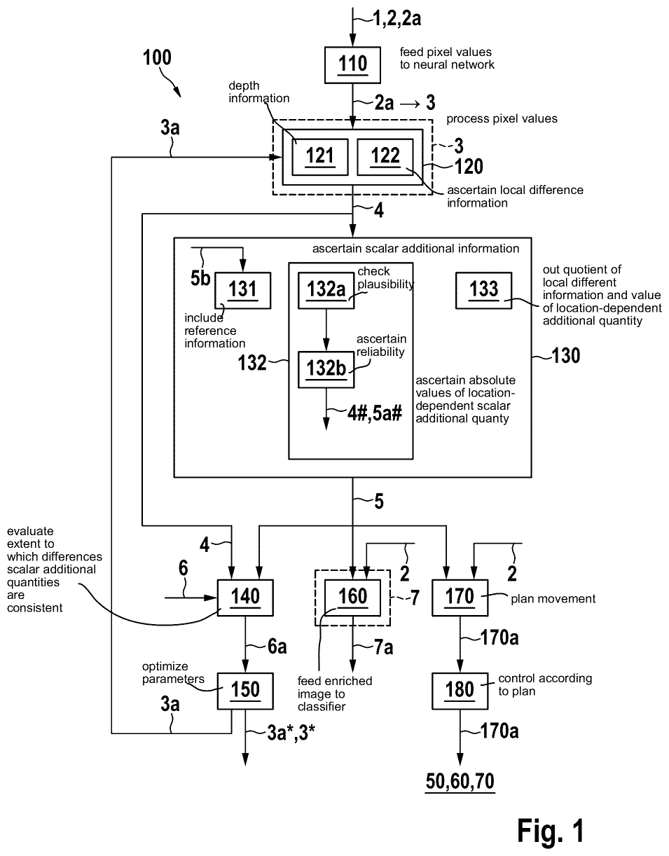

FIG. 1 is a schematic flowchart of an exemplary embodiment of the method 100 for reconstructing a location-dependent scalar additional quantity 5 from an image 2 of a scene 1.

In step 110, pixel values 2a of the image 2 are fed to a neural network 3.

In step 120, the pixel values 2a are processed by the neural network 3 to produce local difference information 4. This local difference information 4 in each case indicates how the location-dependent scalar additional quantity 5 of the scene 1 changes at the position indicated by the particular pixel.

According to block 121, the scalar additional quantity 5 can, for example, in particular include depth information that is a measure of a distance between a part of the scene 1 and a camera used to record the image 2.

According to block 122, the neural network 3 can ascertain local difference information 4 based on a reference pixel, which local difference information includes the changes in the location-dependent scalar additional quantity 5 between the position indicated by the reference pixel, on the one hand, and the positions indicated by various neighboring pixels, on the other hand. This means that multiple local difference information items 4 for different directions are available for each reference pixel.

In step 130, the scalar additional information 5 for further locations indicated by pixels of the image 2 is ascertained from the local difference information 4.

According to block 131, at least one reference indication 5b of the location-dependent scalar additional information 5 for at least one position in the scene 1 can additionally be included in the ascertainment of the scalar additional information 5 for further locations.

According to block 132, the neural network 3 can additionally be designed to ascertain absolute values 5a of the location-dependent scalar additional quantity 5 for the positions indicated by the pixels. It is then possible, for example, in particular according to block 132a, for the absolute values 5a ascertained by the neural network 3, on the one hand, and the ascertained local difference information 4, on the other hand, to be checked against each other for plausibility. According to block 132b, a measure 4 #, 5a #of the reliability of the absolute values 5a and/or the local difference information 4 can then be ascertained from the result of the plausibility check.

According to block 133, the neural network 3 can output a quotient of the local difference information 4 and the value of the location-dependent additional quantity 5 at the position indicated by the particular pixel.

In the example shown in FIG. 1, in step 140, a cost function 6 is used to evaluate the extent to which multiple differences of the scalar additional quantity 5 between two predetermined locations in the scene 1, which differences have been aggregated on different paths from multiple local difference information items 4, are consistent with each other. As explained above, the ascertained local difference information 4 is then referred to as “path-consistent.” An evaluation 6a is produced here.

Subsequently, in step 150, parameters 3a that characterize the behavior of the neural network 3 are optimized with the aim of improving the evaluation 6a by the cost function 6. This optimization can be terminated when any termination criterion is reached. The fully optimized state of the parameters 3a is denoted by reference sign 3a* and also defines the fully trained state 3* of the neural network 3.

In step 160, the image 2 enriched by the ascertained scalar additional quantity 5 can be fed to a classifier network 7. Said classifier network 7 assigns classification scores 7a with respect to one or more classes of a predetermined classification to the scene 1 and/or at least one object contained in the scene 1.

In step 170, the image 2 enriched by the ascertained scalar additional quantity 5 can be included in the planning 170a of the movement of a vehicle 50, a robot 60, and/or a production machine 70 designed to pick up and assemble components. In step 180, the vehicle 50, the robot 60, or the production machine 70 can then be controlled according to this planning 170a.

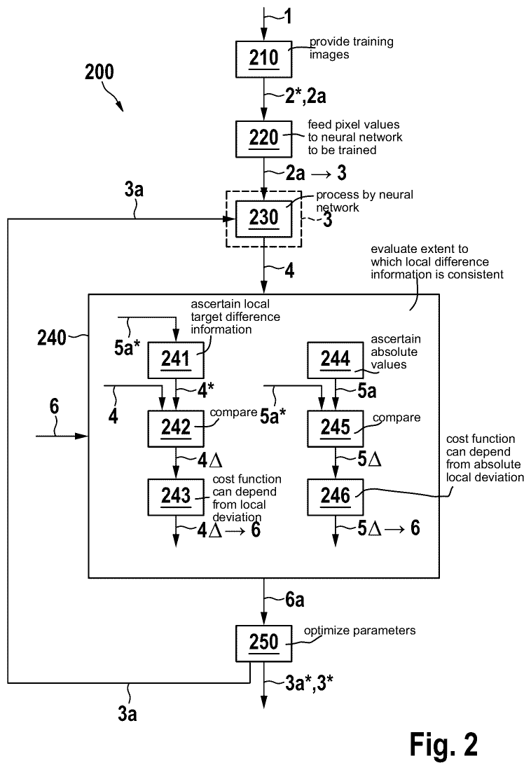

FIG. 2 is a schematic flowchart of an exemplary embodiment of the method 200 for training a neural network 3.

In step 210, training images 2* of at least one scene 1 are provided.

In step 220, pixel values 2a of said training images 2* are fed to the neural network 3 to be trained.

In step 230, the pixel values 2a are processed by the neural network 3 to produce local difference information 4. This local difference information 4 in each case indicates how the location-dependent scalar additional quantity 5 of the scene 1 changes at the position indicated by the particular pixel.

In step 240, a predetermined cost function 6 is used to evaluate the extent to which the ascertained local difference information 4 is consistent with the predetermined target information 5* regarding the location-dependent scalar additional quantity 5* in the scene 1. An evaluation 6a is produced here.

According to block 241, local target difference information 4* can be ascertained from predetermined target absolute values 5a* for the location-dependent scalar additional quantity 5. According to block 242, the ascertained local difference information 4 can then be compared to the local target difference information 4* so that a local deviation 44 is produced. According to block 243, the cost function 6 can then depend on said local deviation 44.

According to block 244, absolute values 5a of the location-dependent scalar additional quantity 5 for the positions indicated by the pixels can be ascertained by the neural network 3 and/or from the local difference information 4 provided by the neural network 3. According to block 245, the absolute values 5a ascertained by the neural network 3 and/or from the local difference information 4 provided by the neural network 3 can then be compared 245 to predetermined target absolute values 5a* so that an absolute deviation 54 is produced. According to block 246, the cost function 6 can then also depend on said absolute deviation 54.

In step 250, parameters 3a that characterize the behavior of the neural network 3 are optimized with the aim of improving the evaluation 6a by the cost function 6. This optimization can be terminated when any termination criterion is reached. The fully optimized state of the parameters 3a is denoted by reference sign 3a* and also defines the fully trained state 3* of the neural network 3.

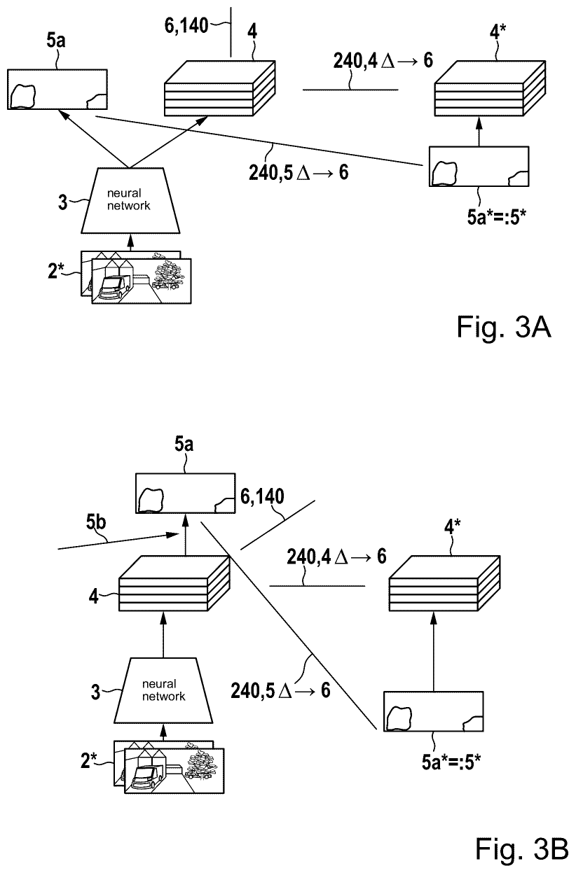

FIGS. 3A and 3B show two different ways of using predetermined target absolute values 5a* as “ground truth” for the training according to the method 200.

According to FIG. 3A, training images 2* are processed by the neural network 3 on the one hand to produce local difference information 4 and on the other hand also to produce absolute values 5a of the desired location-dependent scalar additional quantity 5, here: depth information. Target absolute values 5a* of the scalar additional quantity 5 as target information 5* are available as “ground truth.” On the one hand, said target absolute values 5a* can be used for the direct comparison with the absolute values 5a ascertained by the neural network, so that the resulting absolute deviation 54 can be included in the cost function 6 used in step 240 of the method 200. On the other hand, local target difference information 4* can be ascertained from the target absolute values 5a* in a deterministic manner, for example with a two-dimensional convolution layer. Said local target difference information 4* can then be compared to the local difference information 4 ascertained by the neural network 3, so that the resulting local deviation 44 can also be included in the cost function 6. In addition, the path consistency of the local difference information 4 can also be checked according to step 140 of the method 100.

In the example shown in FIG. 3B, in contrast to FIG. 3A, the neural network 3 does not directly ascertain the absolute values 5a of the scalar additional quantity 5. Instead, said absolute values 5a are evaluated using at least one reference indication 5b of the location-dependent scalar additional information 5 from the local difference information 4 provided by the neural network 3. Otherwise, the target absolute values 5a* are used in a completely analogous manner to FIG. 3A in order to directly evaluate the ultimately ascertained absolute values 5a and indirectly evaluate via local target difference information 4* the local difference information 4 provided by the neural network 3.

What is claimed is:

1. A method for reconstructing a location-dependent scalar additional quantity of a scene from an image of the scene divided into pixels, comprising the following steps:
feeding pixel values of the image to a neural network;
processing each of the pixel values by the neural network to produce respective local difference information, which in each case indicates how a location-dependent scalar additional quantity of the scene changes at a position indicated by the pixel;
ascertaining scalar additional information for further locations indicated by pixels of the image, from the respective local difference information.

2. The method according to claim 1, wherein the scalar additional quantity includes depth information that is a measure of a distance between a part of the scene and a camera used to record the image.

3. The method according to claim 1, wherein the neural network ascertains local difference information based on a reference pixel, the local difference information including changes in the location-dependent scalar additional quantity between the position indicated by the reference pixel, on the one hand, and positions indicated by various neighboring pixels, on the other hand.

4. The method according to claim 1, wherein at least one reference indication of the location-dependent scalar additional information for at least one position in the scene is additionally included in the ascertainment of the scalar additional information for the further locations.

5. The method according to claim 1, wherein:
a cost function is used to evaluate an extent to which multiple differences of the scalar additional quantity between two predetermined locations in the scene, which differences have been aggregated on different paths from multiple local difference information items, are consistent with each other; and
parameters that characterize a behavior of the neural network are optimized with an aim of improving the evaluation by the cost function.

6. The method according to claim 1, wherein the neural network is additionally configured to ascertain absolute values of the location-dependent scalar additional quantity for the positions indicated by the pixels.

7. The method according to claim 6, wherein:
the ascertained absolute values, on the one hand, and the ascertained local difference information, on the other hand, are checked against each other for plausibility; and
a measure of a reliability of the absolute values and/or the local difference information is ascertained from a result of the plausibility check.

8. The method according to claim 1, wherein the neural network outputs a quotient of the local difference information and a value of the location-dependent scalar additional quantity at the position indicated by the pixel.

9. The method according to claim 1, wherein the image enriched by the ascertained location-dependent scalar additional quantity is fed to a classifier network, which assigns classification scores with respect to one or more classes of a predetermined classification to the scene and/or at least one object contained in the scene.

10. The method according to claim 1, wherein:
the image enriched by the ascertained location-dependent scalar additional quantity is included in a planning of the movement of a vehicle, and/or a robot, and/or a production machine configured to pick up and assemble components; and
the vehicle, and/or the robot, and/or the production machine is controlled according to the planning.

11. A method for training a neural network, comprising the following steps:
providing training images of at least one scene;
feeding pixel values of the training images to the neural network to be trained;
processing each of the pixel values by the neural network to produce respective local difference information, which in each case indicates how a location-dependent scalar additional quantity of the scene changes at a position indicated by the pixel;
evaluating, using a predetermined cost function, an extent to which the ascertained respective local difference information is consistent with the predetermined target information regarding the location-dependent scalar additional quantity in the scene; and
optimizing parameters that characterize a behavior of the neural network, with an aim of improving the evaluation by the cost function.

12. The method according to claim 11, wherein:
local target difference information is ascertained from predetermined target absolute values for the location-dependent scalar additional quantity;
the ascertained local difference information is compared to the local target difference information SO that a local deviation is produced; and
the cost function depends on the local deviation.

13. The method according to claim 12, wherein:
absolute values of the respective location-dependent scalar additional quantity for the positions indicated by the pixels are ascertained by the neural network and/or from the local difference information provided by the neural network;
the absolute values ascertained by the neural network and/or from the local difference information provided by the neural network are compared to predetermined target absolute values so that an absolute deviation is produced; and
the cost function also depends on the absolute deviation.

14. A non-transitory machine-readable data carrier on which is stored a computer program including machine-readable instructions for reconstructing a location-dependent scalar additional quantity of a scene from an image of the scene divided into pixels, the instructions, when executed by one or more computers and/or compute instances, cause the one or more computers and/or compute instances to perform the following steps:
feeding pixel values of the image to a neural network;
processing each of the pixel values by the neural network to produce respective local difference information, which in each case indicates how a location-dependent scalar additional quantity of the scene changes at a position indicated by the pixel;
ascertaining scalar additional information for further locations indicated by pixels of the image, from the respective local difference information.

15. One or more computers and/or compute instances equipped with a non-transitory machine-readable data carrier on which is stored a computer program including machine-readable instructions for reconstructing a location-dependent scalar additional quantity of a scene from an image of the scene divided into pixels, the instructions, when executed by the one or more computers and/or compute instances, cause the one or more computers and/or compute instances to perform the following steps:
feeding pixel values of the image to a neural network;
processing each of the pixel values by the neural network to produce respective local difference information, which in each case indicates how a location-dependent scalar additional quantity of the scene changes at a position indicated by the pixel;
ascertaining scalar additional information for further locations indicated by pixels of the image, from the respective local difference information.
